(19) United States
(12) Patent Application Publication
(10) Pub. No.: US 2026/0078586 A1
(43) Pub. Date: Mar. 19, 2026

(54) ROBOT-DEPLOYABLE ACCESSIBILITY SYSTEM

(71) Applicant: UNITED KINGDOM ATOMIC ENERGY AUTHORITY, Abingdon, Oxfordshire (GB)

(72) Inventors: Jeff SLATER, Abingdon (GB); Guy BURROUGHES, Abingdon (GB); Jon VERDON, Abingdon (GB); Rob BUCKINGHAM, Abingdon (GB)

(73) Assignee: UNITED KINGDOM ATOMIC ENERGY AUTHORITY, Abingdon, Oxfordshire (GB)

(21) Appl. No.: 19/482,120

(22) PCT Filed: May 8, 2024
(86) PCT No.: PCT/GB2024/051193

§ 371 Date: Nov. 6, 2025

(30) Foreign Application Priority Data
May 9, 2023 (GB) 2306823.2

(51) Int. Cl. E04F 11/035; E04F 11/00; E04F 11/06

(52) U.S. Cl. CPC E04F 11/035; E04F 11/002; E04F 11/06; E04F 2011/005

(57) ABSTRACT

A module for use in a robot-deployable modular accessibility system. The module includes a block, an attachment portion, and a gripping portion. The attachment portion is configured to attach the module to another module. The gripping portion is configured to enable a robot to grip and handle the module. The robot-deployable modular accessibility system includes a plurality of modules. The plurality of modules is configured to be assembled by the robot to form a structure. Also, a method of assembling the robot-deployable modular accessibility system by a robot.

The present disclosure relates to a robot-deployable accessibility system and associated apparatus and method, configured to improve the mobility of quadruped and other, such as tracked, robotic platforms. The system is suitable for use in various hostile or hazardous environments, for example, sites including radioactive or contaminated materials that may cause harm to humans and require robotic intervention.

Working in radioactive, contaminated, hazardous, or otherwise hostile environments can pose serious health risks to humans. Examples of this work can include the maintenance, processing, and examination of radioactive materials as might be used in nuclear reactors. These tasks are necessary for the safe operation of reactors and during decommissioning activities. Other examples of hostile environments may include disaster relief and recovery, and security or surveillance-related activities. In the case of radioactive or contaminated environments, excessive exposure can dramatically increase the likelihood of long-term health issues including radiation sickness and cancer. Therefore, it is preferable to avoid human interaction wherever possible.

Recent developments in robotic technology have provided robotic platforms that are capable of replacing humans. Moreover, robots are capable of operating in these hazardous environments without the same susceptibilities as humans. Several leading robotic platforms are based on quadrupeds. These quadruped platforms may provide a stable and adaptable platform suitable for operations in hostile environments such as those described above. Quadruped robotic platforms are still a relatively new concept and so, many of their potential applications have yet to be realized.

Robotic platforms may be fitted with arms, appendages, or other tools to facilitate interaction and manipulation of objects within the robot's reach. Robotic platforms may be limited by their reach and lifting capacity. For example, the lift capacity may only be a few kilograms. The maximum reach of these platforms may be limited to only a couple of metres. Despite recent advances, the movement of robotic platforms is still limited by the local environment and/or conditions. Depending on their design, robotic platforms may have limited mobility in certain environments. These environments may introduce further challenges regarding the stability of the robotic platform, particularly if the robot is carrying a payload. These environmental limitations can reduce the autonomy of the robotic platform, thereby further reducing its effectiveness and increasing the likelihood of human interaction which is not desirable in hostile environments such as those described above.

These issues, amongst others, can limit the operational effectiveness of robotic platforms. It is for desirable robotic platforms to maintain autonomy and minimize the need for human intervention. It is the object of the invention described herein to address and overcome at least some of the problems outlined above.

In view of the limitations discussed above, there is a need for accessibility systems, such as modular step or ramp arrangements which are capable of being carried, manipulated, and assembled by robotic platforms in an autonomous or semi-autonomous fashion. Such systems might consist of stairs or ramps configured to facilitate the access needs of a wider range of autonomous vehicles and systems.

According to the present invention there is provided an apparatus and method as set forth in the appended claims. Other features of the invention will be apparent from the dependent claims, and the description which follows.

According to aspect, there is provided a module for a robot-deployable modular accessibility system comprising a block; an attachment portion; and a gripping portion. The attachment portion is configured to attach the module to another module. The gripping portion is configured to enable a robot to grip and handle the module. This arrangement provides a simple apparatus that can be used by a robot to assemble a larger structure capable of being traversed by the robot to provide access to otherwise inaccessible areas.

The module may comprise a top surface having at least one vertical locating feature. The vertical locating feature may be configured to provide alignment between the module and another module. This arrangement enables the robot to properly align modules during the assembly of a structure. This also improves the final stability of the structure when assembled.

The vertical locating feature may be a projection that projects from an upper surface of the module. The vertical locating feature may be receivable in a recess in a bottom surface of another module. The vertical locating feature may be tapered or slimmer than the recess in the bottom surface of the another module, which may help the modules to self-align when being stacked by a robot.

The attachment portion of the module may comprise a horizontal locking feature. The horizontal locking feature is configured to lock the module to another module. This arrangement enables neighbouring/adjacent modules to be interlocked, thereby improving the stability of the assembled structure.

The horizontal locking feature comprises a horizontal locking protrusion and a horizontal locking recess. The horizontal locking protrusion is configured to slot into a horizontal locking recess of the attachment portion of a first other module. The horizontal locking recess is configured to receive a horizontal locking protrusion of a second other module. This arrangement enables a module to interlock with multiple neighbouring/adjacent modules to be interlocked in a simple yet secure way, thereby improving the stability of the assembled structure.

The attachment portion of the module may be an endcap provided at an end portion of the block. This arrangement enables the block and attachment portion or endcap to be formed separately and of different materials. For example, the block may be formed of a material that is less dense than the endcap, to reduce the weight of the module, whilst the endcap may be formed of a more hard-wearing material to improve the stability of assembly. This arrangement further enables the design of the attachment portion or endcap to be modified without requiring the whole module to be redesigned and replaced.

The gripping portion may be located on a front surface and/or a top surface of the block. The gripping portion comprises a slot configured to receive at least a part of a robot gripper to allow the robot to handle the module. This arrangement ensures that the gripping portion is located in an optimal location for safe and stable handling by the robot. This arrangement also ensures that the gripping portion is suitable for handling by the robot to prevent the module from being dropped or similarly mishandled. The slot is further beneficial in that an insert may be received therein.

The insert may configured to be received in the slot of the gripping portion. The insert may be formed of a more hard-wearing material than the block. This arrangement allows interchangeable inserts to be used that may be changed based on the robot or gripper tool being used by the robot. This arrangement may further improve the longevity of the gripping portion and module by protecting the block element from repeated handling.

The module may be a step module comprising a substantially vertical front surface. This arrangement provides a simple to produce module that is easily stackable and can be combined to form a wide variety of stable structures. This may allow the robot to stack the step modules to assemble a set of steps which may be climbed by the robot.

The module may be a ramp module, wherein the block comprises at least one sloped surface. By providing a sloped surface, a wider range of robotic platforms may utilize the structure formed by combining a plurality of modules. For example, wheeled and tracked platforms may be used that may otherwise be unable to ascend a structure formed only of step modules.

The ramp module may comprise a sloped surface that is inclined at an angle not exceeding 30 degrees from the horizontal. This arrangement may reduce the likelihood of various robotic platforms being restricted in their movement up/along a ramp module and the assembled structure.

The module may comprise an identification marker. The identification marker may be configured to be scanned by the robot to identify the module and may provide instructions relating to the layout of a structure to be assembled and/or the location of the module within the structure. This arrangement allows the robotic platform to scan modules and obtain identification and assembly information that may assist the robot during the assembly of a structure.

The module may comprise a surface cover. The surface cover may be configured to be coupled to the top surface of the block, wherein the surface cover is formed of a stronger material than the block. This arrangement provides the module with a protective cover that can improve the durability of the module, thereby extending its lifetime of use. The surface cover may also have a functional surface, for example, to improve the traction or grip of the robot.

According to another embodiment of the present disclosure is a robot-deployable modular accessibility system comprising a plurality of the modules described above. The plurality of modules is configured to be assembled by the robot to form a structure. This arrangement allows a plurality of modules to be arranged to form a useful structure, such as a stairway, platform, or the like, that can be used to provide access to previously inaccessible locations.

The modular accessibility system may comprise a cap module. The cap module is configured to attach to an upper surface of at least one of the plurality of modules. This arrangement provides a further module to the system to improve the flexibility of the system, thereby enabling the system to be used in a wider range of environments. This arrangement also defines the upper layer of the system and prevents additional modules from being placed.

The cap module of the modular accessibility system may comprise a sloped upper surface. This arrangement provides finer adjustment over the total height of the assembled structure. This may provide a smooth transition between the assembled structure and the location being accessed.

The cap module of the modular accessibility system may further comprise rails along the side edges of the top surface of the module. This arrangement prevents robotic platforms, particularly wheeled or tracked platforms, from accidentally driving over the edge of the assembled structure. This arrangement also more clearly defines the accessway provided by the assembled structure.

According to another embodiment of the present disclosure is a method of assembling a plurality of modules by stacking and interlocking the plurality of modules to form a structure. The method includes the steps of retrieving at least one module from the plurality of modules; handling, via the gripping portion of the module, the at least one module from a plurality of modules; and assembling the plurality of modules by stacking and interlocking the plurality of modules to form a structure. This arrangement provides a method for utilizing a plurality of modules to form a useful structure that may improve access to an inaccessible location, by a robot platform.

The method may further comprise the steps of scanning, by the robot, an identification marker located on the at least one module; and assembling the plurality of modules autonomously according to instructions obtained from the scanned identification marker. This arrangement provides a method whereby a robot may autonomously identify modules and assemble these into a pre-defined structure.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

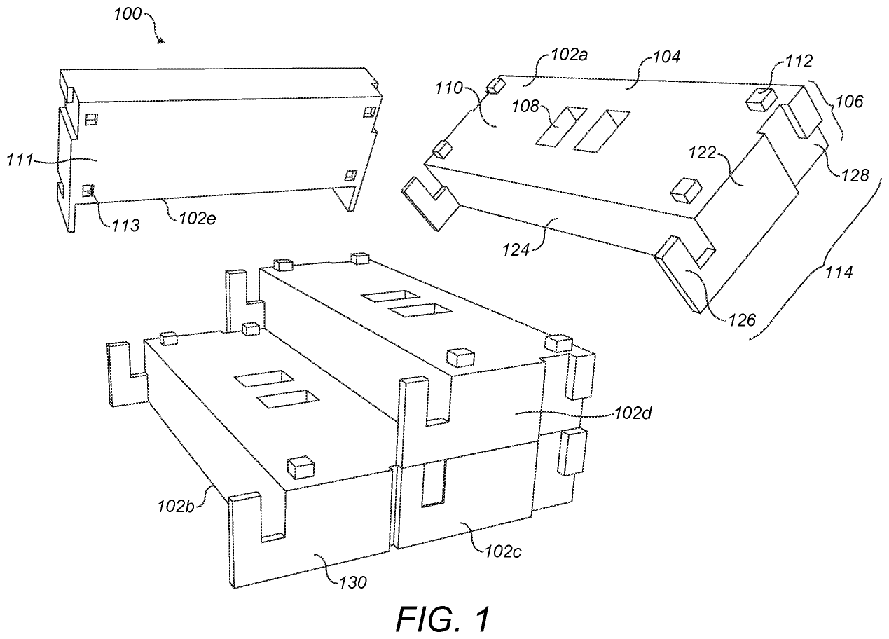

FIG. 1 shows a first embodiment of a robot-deployable modular accessibility system formed by combining and assembling a plurality of modules into a structure;

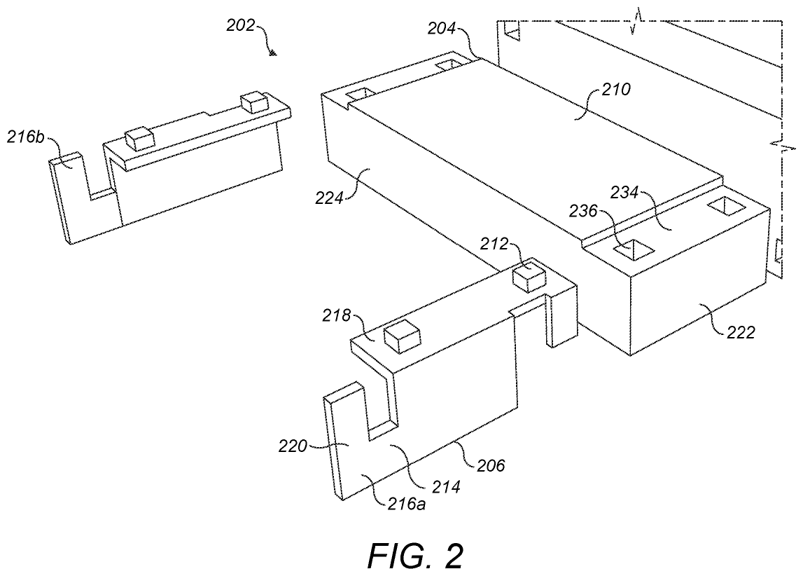

FIG. 2 shows an embodiment of a robot-deployable modular accessibility system, specifically, a module for use in a robot-deployable modular accessibility system;

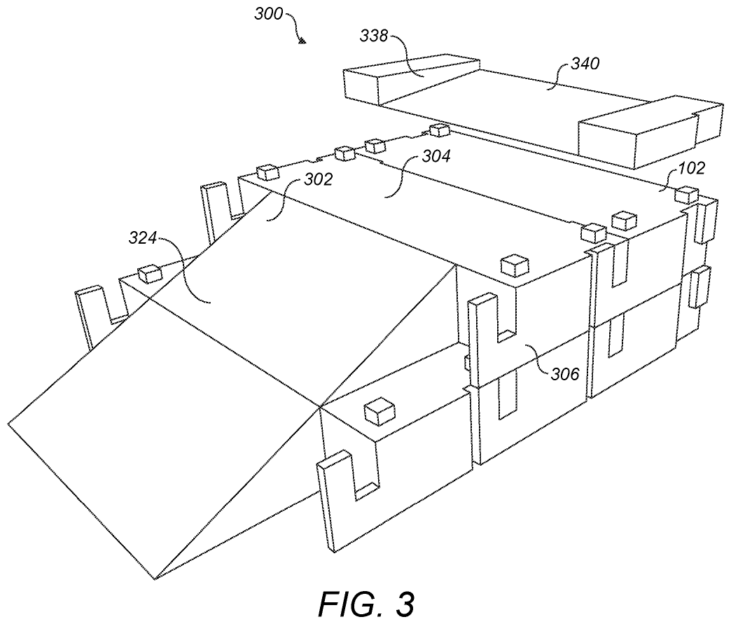

FIG. 3 shows another embodiment of the robot-deployable modular accessibility system including ramp sections;

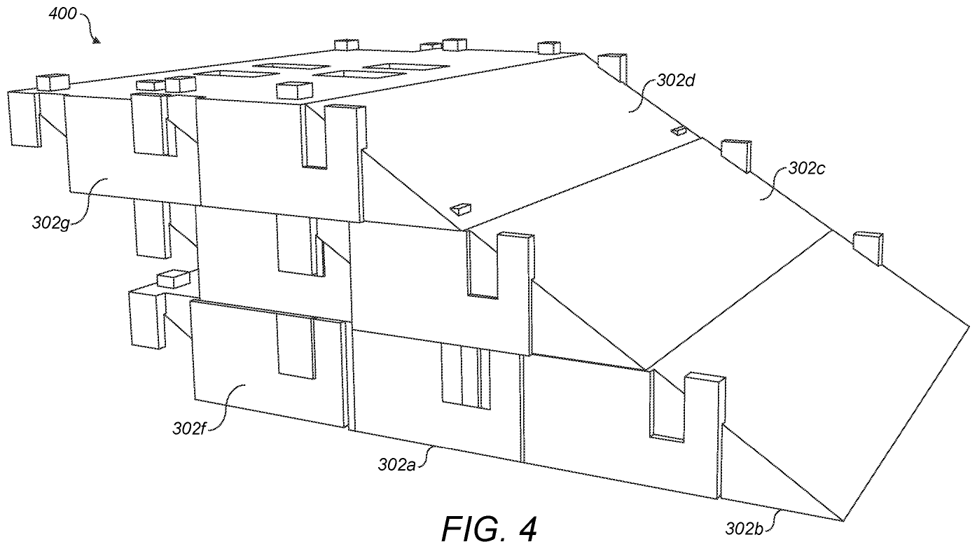

FIG. 4 shows another embodiment of the robot-deployable modular accessibility system including ramp modules; and

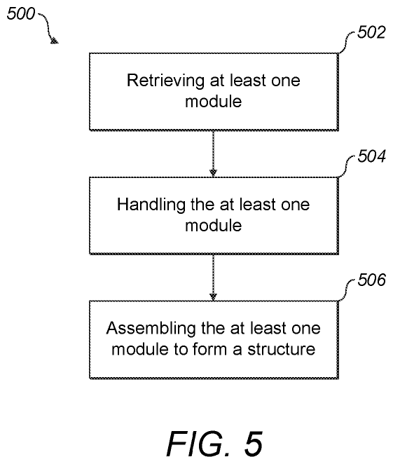

FIG. 5 shows a method of assembling a robot-deployable modular accessibility system, as described in relation to FIGS. 1-4.

Hereinafter, various examples will be described with reference to the accompanying figures. The examples described below may be modified and implemented in various different forms. In order to more clearly describe features of the examples, detailed descriptions of matters well known to those skilled in the art to which the following examples belong will be omitted.

In the present disclosure, when an element is described as “connected” or “coupled” with another element, this includes not only “directly connected” or “directly coupled”, but also “connected with another element therebetween” or “coupled with another element therebetween”. In addition, when one element is described to “include” another element, this means that, unless specifically stated otherwise, the one element may further include other elements rather than excluding other elements.

FIG. 1 illustrates a first embodiment of a robot-deployable modular accessibility system 100. The system 100 comprises a plurality of modules 102. The modules 102 are configured to be assembled together, by a robot, to form a structure. The structure may be, for example, a set of steps, to provide accessibility for a robot or other vehicle. The structure is configured to be traversed by the robot to gain access to otherwise inaccessible locations, such as ledges, laddered areas, and the like. The plurality of modules is be configured to support the weight of the robot. The plurality of modules may be further configured to support the weight of the robot while the robot is carrying a payload. The robot may be, for example, a robotic quadruped. FIG. 1 shows modules 102b, 102c and 102d assembled into a set of steps structure 130, with modules 102a and 102e yet to be assembled in the structure.

Each module 102 of the plurality of modules comprises a block 104, an attachment portion 106, and a gripping portion 108. The block 104 forms a majority of the volume of the module 102 and supports the weight of the robot during use. The block 104 is substantially cuboidal in shape, comprising a top surface 110, a front surface 124, a pair of end surfaces 122, a bottom surface 111, and a back surface.

As FIG. 1 shows, the attachment portion 106 is integral with the block 104. However, in other embodiments, as discussed in relation to FIG. 2, the attachment portion 206 can take the form of an endcap 216. Returning to FIG. 1, the attachment portion 106 is configured to attach to the attachment portion 106 of another module 102 from the plurality of modules. The attachment portion 106 is located proximal to the end surface 122 of the block 104. Each module 102 comprises a pair of attachment portions 106 that are located at opposite ends of the module 102 located proximal to the end surfaces 122 of the block 104.

The top surface 110 of the module 102 comprises a vertical locating feature 112. As shown in FIG. 1, the attachment portion 106 comprises four vertical locating features 112. In other examples, the attachment portion may comprise more or fewer than four vertical locating features. The vertical locating feature 112 is configured to provide alignment between modules 102 during assembly of the system 100. The at least one vertical locating feature 112 also serves the purpose of improving the stability of modules 102 when stacked vertically. The vertical locating feature 112 comprises a projection. The projection be configured to fit within a recess 113 located in a complementary position on the bottom surface 111 of another module 102. The projection fits within the recess 113 when the plurality of modules 102 are stacked vertically. The projection and recess 113 may be shaped such that the two only fit when the modules 102 are aligned in a specific orientation. The vertical locating feature may be tapered or slimmer than the recess in the bottom surface of the another module, which may help the modules to self-align when being stacked by a robot.

The attachment portion 106 further comprises a horizontal locking feature 114. The horizontal locking feature 114 of one module 102 is configured to interlock with the horizontal locking feature 114 of another module 102 from the plurality of modules. Interlocking the plurality of modules in this way can improve the horizontal stability of the assembled structure. The horizontal locking feature 114 comprises a horizontal locking protrusion 126 and a horizontal locking recess 128. The locking protrusion 126 is hook-shaped and the locking recess 128 has a complementary shape to receive a hook-shaped locking protrusion 126 of another module 102. The module 102 comprises a horizontal locking feature 114 at opposing ends of the block 104, thereby providing at least two points of attachment for modules positioned in front and behind the module 102.

The gripping portion 108 is configured to be gripped by a robot. The gripping portion 108 is configured to enable the robot to lift, move, manipulate, manoeuvre, or otherwise arrange the module 102 during the assembly of a structure. The gripping portion 108 may have a geometry that is complementary to a manipulator tool, gripper mechanism, or arm of the robot in order to facilitate gripping and subsequent handling of the module 102. The gripping portion 108 is in a substantially central position on the block 104 to provide stability when being handled by the robot.

The gripping portion 108 of the module 102 is located on the top surface 110 of the block 104. In other examples, the gripping portion may be located on the front surface of the block. The module 102 may comprise a plurality of gripping portions located on different surfaces of the block 104 to increase the accessibility of the module 102.

The gripping portion 108 comprises one or more slots. In use, a robot inserts its end effector into the one or more slots to grip the module 102. The slot may be configured to receive an insert (not shown). The insert lines the slot and is formed of a material that is more hard-wearing than the block 104. This increases the durability of the gripping portion 108 during repeated handling by the robot.

The structure is formed by stacking and interlocking the plurality of modules starting with a base or foundation of modules 102. The structure is then built upwards until a desired height is reached.

The system 100 is configured to be assembled by the robot in situ, i.e., at the location where access is required, rather than pre-assembled and then moved to the location where access is required. The system 100 is assembled into a structure through a combination of vertically stacking and horizontally interlocking modules 102.

The module 102 may further comprise a surface cover (not shown). The surface cover is configured to be coupled to the top surface 110 of the block 104. The surface cover is formed of a stronger material than the block, thereby increasing the durability of the block 104 during repeated use as a traversable surface.

The block elements 104 are formed of a lightweight material to allow ease of handling by the robot. Suitable lightweight materials can include plastics, such as polystyrene. The modules 102 and various components thereof may be produced using injection moulding techniques, additive manufacturing techniques, such as 3D printing, and the like. The total mass of a single module 102 is preferably no more than approximately 2 kilograms, thereby allowing the robot to handle and manipulate modules 102 safely and competently. The combination of the lightweight bulk deck material, with only denser, heavier, hardwearing materials being used where necessary to stabilize and secure the steps, means the module weight is kept to a minimum.

FIG. 2 illustrates another example module 202. The module 202 may be used to assemble a structure as shown in the system 100 of FIG. 1 and/or the system 300 of FIG. 3. The module 202 comprises a block 204, an attachment portion 206, and a gripping portion (not shown). FIG. 2 shows the module in a disassembled state, prior to the attachment portion 206 being attached to the block 204. As FIG. 2 shows, the attachment portion 206 takes the form of an endcap 216 configured to be attached to the block 204 at an end portion of the block 204. The endcap 216 comprises the vertical locating features 212 and the horizontal locking features 214 corresponding substantially to the vertical locating features 112 and horizontal locking features 114 of the module 102 of FIG. 1. As shown in FIG. 2, the module comprises two endcaps 216a, 216b configured to engage opposite ends of the block element 204.

The endcap 216 engages with an endcap attachment portion 234 of the block 204. The endcap 216 is then secured to the block 204 by permanent or reversible means. The endcap engagement portion 234 comprises at least one endcap recess 236. The endcap recess 236 is configured to receive a complimentary endcap alignment projection (not shown) located on the underside of the endcap 216, thereby providing a secure fit between the block 204 and endcap 216.

The endcap 216 comprises a first surface 218 and a second surface 220. The first surface 218 and the second surface 220 is arranged substantially normal to one another so as to fit about the end portion and endcap engagement portion 234 of the block 204. The first surface 218 of the endcap 216 is configured to abut the top surface 210 of the block 204. The second surface 220 is configured to abut an end surface 222 of the block 204. The first surface 218 comprises top and bottom faces. The bottom face of the first surface 218 comprises the endcap alignment projection. The top face of the first surface 218 comprises the vertical locating feature 212. The second surface 220 of the endcap 216 may include additional alignment features to improve the stability of the coupling between the endcap 216 and the end surface 222 of the block 204.

According to the embodiment of FIG. 2, the end cap 216 is formed of a different material to the block 204. The block 204 is formed of a light-weight material such as polystyrene, whereas the endcap 216 is formed of a material that is denser and stronger than the block 204. The endcap 216 is thereby more hardwearing, to improve the durability and stability of the module 202.

FIG. 3 illustrates a further embodiment of a robot-deployable modular accessibility system 300. As FIG. 3 shows, the system 300 includes multiple different modules including a combination of at least one step module 102 and at least one ramp module 302. The step modules 102 comprise a substantially vertical front surface. The step modules 102 form a majority of the modules used during assembly of the structure.

The ramp module 302 comprises an attachment portion corresponding to the attachment portion of the module 102 shown in FIG. 1. The ramp module 302 also comprises a gripping portion (not shown). The ramp module 302 comprises at least one sloped surface. Preferably, the sloped surface of the ramp module 302 is formed by inclining the front surface 324 of the block 304. The ramp module 302 comprises a larger footprint than the step module 102, with an extended bottom surface (not shown), and a front surface 324 that is inclined. The ramp module 302 is arranged such that only a central portion of the front surface 324 of the block 304 is sloped, thereby leaving the attachment portions 306 free to interact with other modules 102, 302 as described above.

The incorporation of one or more ramp modules 302 can enable a variety of other robotic platforms to use the assembled structure. Other robotic platforms may comprise wheels or tracks which would not be capable of using the system 100 otherwise. The inclination of the front surface 324 is no more than 30 degrees to the horizontal to improve accessibility for such wheel-or track-based robotic platforms.

In this embodiment, the system 300 is formed of a combination of step modules 102 and ramp modules 302. In another embodiment, the accessibility system is formed only of ramp modules 302, as discussed below in relation to FIG. 4.

Returning to FIG. 3, the system 300 further comprises at least one cap module 340. The cap module 340 is configured to overlay a module 102, 302. The cap module 340 is the last module 340 to be placed during assembly of a structure. In other words, the cap module 340 defines the top layer of an assembled system 300. The cap module 340 comprises a sloped surface and is configured to raise the height of the structure to a desired height. The height of the cap module 340 is less than the height of a ramp module 302 and enables the structure to be assembled to a desired height.

The cap module 340 comprises rails 338. The rails 338 are positioned on the top surface of the cap module 340 adjacent to the end surfaces of the cap module 340. The rails 338 are configured to limit the movement of robots using the system 300. For example, rails 338 can prevent treaded or wheeled robotic platforms from driving off the edge of the assembled structure. The cap module 340 may also be flat and provide a functional surface, for example, to enhance grip or traction for the robot.

Each module 102, 302, 340 comprises an identification or fiducial marker (not shown). The identification marker is configured to be scanned by the robot to provide automatic recognition of the module 102, 302, 340. The identification marker further provides the robot with instructions relating to the layout of the accessibility system. For example, the instructions convey the layout of the structure, stairway, platform, or the like, and indicate to the robot where the scanned module 102, 302, 340 is to be positioned within the structure. The identification marker may be at least one of a machine-readable marker, such as a QR code. The identification marker arrangement is applicable to any of the modules or systems described herein. The skilled person will appreciate that the various other arrangements may be used to convey the same or similar information to the robot before and/or during use of the system 100, 300.

FIG. 4 illustrates a further embodiment of a robot-deployable modular accessibility system 400. As FIG. 4 shows, the system 400 is primarily formed using only ramp modules 302, rather than a combination of step modules 102 and ramp modules 302.

The present disclosure further relates to a method 500 of assembling a modular accessibility system 100, 300, 400 as described above in relation to the embodiments of FIGS. 1-4. FIG. 5 shows a flow chart containing the steps involved with the method 500. The method 500 is to be carried out by a robot. The robot may be controlled by an operator, or the robot may carry out the method autonomously.

The method 500 includes the step 502 of retrieving at least one module 102, 202 302 from a plurality of modules. The robot retrieves the at least one module 102, 202, 302 according to instructions provided by an operator. Alternatively, the robot retrieves the at least one module 102, 202, 302 autonomously according to self-determined accessibility requirements.

The method 500 further includes the step 504 of handling the at least one module 102, 202, 302. The module is configured to be handled by the robot via a gripping portion. Handling of the at least one module 102, 202, 302 encompasses a variety of movements and/or manoeuvres that are applied in order to accurately position the module 102, 202, 302 according to instructions relating to the structure being assembled.

The method 500 further includes the step 506 of assembling a plurality of modules. The structure is configured to provide the robot with improved accessibility. The structure can be, for example, a stairway, a ramp, a platform, or the like. The skilled person will appreciate that the specific arrangement of the structure may take on various other forms based on the accessibility requirements of the surrounding environment and/or the robotic platform.

The method 500 further comprises the step of scanning, by the robot, an identification marker located on the at least one module 102, 202, 302. The method 500 also comprises the step of assembling the plurality of modules autonomously according to instructions obtained from the scanned identification marker.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Reference in the specification to “an example”, “an embodiment”, “an aspect” or similar language means that a particular feature, structure, or characteristic described in connection with the example is included in at least one example, but not necessarily in other examples. The various instances of the phrase “in one example” or similar phrases in various places in the specification are not necessarily all referring to the same example. In describing and claiming examples disclosed herein, the singular forms “a”, “an”, and “the” include plural references unless the context clearly dictates otherwise.

While several examples have been described in detail, it is to be understood that the disclosed examples may be modified. Therefore, the foregoing description is to be considered non-limiting. It should be understood that the examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made.

1. A module for a robot-deployable modular accessibility system, the module comprising:
a block;
an attachment portion, configured to attach the module to another module; and
a gripping portion, configured to enable a robot to grip and handle the module.

2. The module of claim 1, wherein the block comprises a top surface having at least one vertical locating feature configured to provide alignment between the module and another module.

3. The module of claim 1, wherein the attachment portion comprises a horizontal locking feature for locking the module to another module.

4. The module of claim 3, wherein the horizontal locking feature comprises:
a horizontal locking protrusion; and
a horizontal locking recess;
wherein the horizontal locking protrusion is configured to slot into a horizontal locking recess of the attachment portion of a first other module, and
wherein the horizontal locking recess is configured to receive a horizontal locking protrusion of a second other module.

5. The module of claim 1, wherein the attachment portion is an endcap provided at an end portion of the block.

6. The module of claim 1, wherein the gripping portion is located on at least one of a front surface and/or a top surface of the block, wherein the gripping portion comprises a slot configured to receive at least a part of a robot gripper to allow the robot to handle the module.

7. The module of claim 6, wherein an insert is received in the slot, the insert being formed of more hard-wearing material than the block.

8. The module of claim 1, wherein the module is a step module, wherein the block comprises a substantially vertical front surface.

9. The module of any of claim 1, wherein the module is a ramp module, wherein the block comprises at least one sloped surface.

10. The module of claim 9, wherein the sloped surface of the block is inclined at an angle not exceeding 30 degrees from the horizontal.

11. The module of claim 1, wherein the module comprises an identification marker configured to be scanned by the robot to identify the module and provide instructions relating to the layout of a structure to be assembled and/or the location of the module within the structure.

12. The module of claim 1, wherein the module further comprises a surface cover configured to be coupled to the top surface of the block, wherein the surface cover is formed of a stronger material than the block.

13. A robot-deployable modular accessibility system comprising a plurality of the modules according to claim 1,
wherein the plurality of modules is configured to be assembled by the robot to form a structure.

14. The modular accessibility system of claim 13, further comprising a cap module, wherein the cap module is configured to attach to an upper surface of at least one of the plurality of modules.

15. The modular accessibility system of claim 14, wherein the cap module comprises a sloped upper surface.

16. The modular accessibility system of claim 14, wherein the cap module comprises rails along the side edges of the top surface of the module.

17. A method of assembling the robot-deployable modular accessibility system of claim 13 by a robot, the method comprising the steps of:
retrieving at least one module from the plurality of modules;
handling, via the gripping portion of the module, the at least one module from a plurality of modules; and
assembling the plurality of modules by stacking and interlocking the plurality of modules to form a structure.

18. The method of claim 17, further comprising the steps of:
scanning, by the robot, an identification marker located on the at least one module; and
assembling the plurality of modules autonomously according to instructions obtained from the scanned identification marker.
